(19) United States
(12) Patent Application Publication
(10) Pub. No.: US 2005/0038572 A1
(43) Pub. Date: Feb. 17, 2005

(54) System and method for refuse collection

(75) Inventor: William J. Krupowicz, Geneva, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Elgin Sweeper, Elgin, IL (US)

(21) Appl. No.: 10/830,361

(22) Filed: Apr. 22, 2004

Related U.S. Application Data
(60) Provisional application No. 60/464,513, filed on Apr. 22, 2003.

(51) Int. Cl. G06F 7/00

(52) U.S. Cl. 700/305

(57) ABSTRACT

A system and method for collecting refuse is disclosed which can include a database including a customer profile having a database record. A collection vehicle can be provided that includes a storage area for receiving refuse and a weighing system for determining the weight of the refuse collected. A database record of the refuse weight can be transmitted to the database. The collection vehicle can include a transmission system for transmitting the data of the database to a remote communication system. The communication system can automatically bill the customer for the collection services provided and transfer funds from the customer's account to the collector's account. The communication system can generate a communication to the customer which includes the data from the customer's customer profile and billing information.

### CROSS-REFERENCE TO RELATED PATENT APPLICATION

This patent application claims the benefit of priority to U.S. Provisional Patent Application No. 60/464,513, filed Apr. 22, 2003, and entitled “System and Method for Refuse Collection,” which is incorporated in its entirety herein by this reference.

### FIELD OF THE INVENTION

The present invention relates generally to refuse collection and, more particularly, to systems and methods for refuse collection including mobile collection vehicles.

### BACKGROUND OF THE INVENTION

The collection of trash is a service industry. Any activity that a trash collection provider engages in, and devotes resources toward, that does not contribute directly to the provider's profitability or to an increased level of service for the provider's customers can be viewed as adversely affecting the provider's business. Spending by the trash collector on sales and general administrative expenses (SGA) in connection with accounts receivable can be viewed as not adding value to the enterprise.

The trash collection provider has limited options to differentiate itself from other trash collectors in the industry with the industry moving toward an increased level of homogeneity. Typically, trash collectors use a similar revenue system which charges customers a fixed monthly fee without taking into account the amount of trash actually collected from each respective customer. Furthermore, the typical collection vehicle does not have the capability to optimize vehicle performance based on a particular customer or to optimize the route for collection which minimizes fuel usage and noise generation.

### SUMMARY OF THE INVENTION

The present invention provides a refuse collection system and a method for collecting refuse which can include a database of customer profiles, each having a plurality of database records, a mobile collection vehicle, a performance control system, a data collection system, a data transmission system, and a trash hauler's business communication system. The refuse collection system according to the present invention can enhance a trash collector's cash flow, reduce its SGA spending, reduce fuel costs, and enhance its service for its customers.

The collection vehicle can include a storage area for receiving refuse and a weighing system for determining the weight of the refuse collected. The weighing system can generate a database record of the refuse weight. The record can be sent to the database for storage in association with the customer profile of the customer whose refuse is being collected. The transmission system can be provided for transmitting the data of the database to the remote business communication system.

The customer profile can include a customer location record. The collection vehicle can include a global positioning system (GPS) for determining a collection vehicle location. A customer profile can be retrieved from the database by matching the collection vehicle location with an associated database record of the customer location.

The customer profile can include a database record of a collection vehicle operating parameter. The performance control system or control unit can retrieve the collection vehicle operating parameter record from the database and can control the operation of the collection vehicle according to the retrieved database record.

The refuse collection system can include a container for storing refuse to be collected by the collection vehicle. The container can be disposed at the customer location. The refuse system can include a plurality of containers of different sizes and/or capacities. Each container can include an identifier element, such as a bar code. The collection vehicle can include a reader for reading the bar code and be operably arranged with the database to match the bar code read by the reader with an associated database record of a container identifier element attributed to a particular customer profile.

Each customer's customer profile can be updated after each collection. The remote communication system can generate a communication to the customer which includes the data of the customer's customer profile. The communication can take any suitable form such as a written communication, an electronic communication, e-mail for instance, or an audio communication, for example. The business communication system can generate a bill which can be part of the communication sent to the customer. The communication system can also automatically deduct a payment from the customer's account by, for example, electronic funds transfer (EFT) or a credit transaction.

The features of the present invention will become apparent to one of ordinary skill in the art upon reading the detailed description, in conjunction with the accompanying drawings, provided herein.

### BRIEF DESCRIPTION OF THE DRAWINGS

FIG. 1 is a flowchart representing steps in a method for collecting refuse according to the present invention which can be carried out by a system for collecting refuse according to the present invention.

### DETAILED DESCRIPTION OF EMBODIMENTS OF THE INVENTION

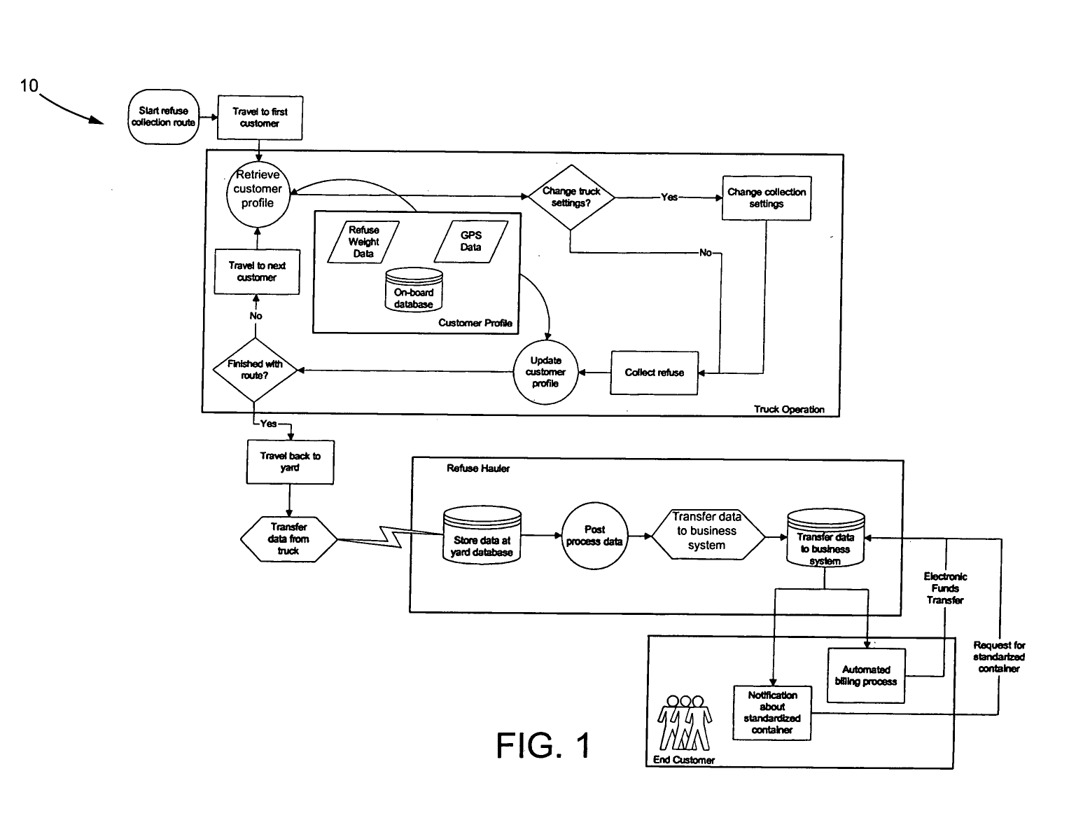

In accordance with the teachings of the present invention and with reference to FIG. 1, there is provided an embodiment of a system for refuse collection. FIG. 1 schematically depicts a method for collecting refuse according to the present invention which can be carried out by a system for collecting refuse 10 according to the present invention. The refuse collection system includes a database having a customer profile for each customer. The customer profile can include a plurality of database records which store data for use with a GPS, such as, coordinates of the customer location being serviced, for example. The customer profile can include other data, such as the description of customer, such as, residential or commercial, for example, the number of containers at the customer location, the container size at the customer location, the identification of the containers at the customer location, the projected weight to be collected from the customer location at each collection, and the rate class at which the customer is billed with different classes being charged a different rate for collection services, for example.

The refuse collection system can include a container for use at each customer location. Each container can include a bar code provided with a unique identification number which can be attributed to the particular customer location at which the container is situated. The refuse collection system can include a plurality of containers which have different sizes and/or capacities.

The refuse collection system can include a mobile collection vehicle, such as, a truck, for example. The collection vehicle can include a lifting mechanism for automatically emptying the container. The collection vehicle can include a storage area for receiving refuse and an onboard weighing system to measure the amount of trash collected from a particular container at a customer location. The collection vehicle can include a data recording and transmission system which is capable of storing, recording, and modifying a plurality of records relating to a corresponding plurality of records relating to a corresponding plurality of parameters, such as, customer information, location, weight of refuse collected, container emptied (e.g., whether it is a standardized container), time collection vehicle was at customer location, date collection vehicle was at customer location, and digital photograph of location, for example, and transmitting the data to a remote location, via cellular or radio frequency (RF) technology, for example.

Each mobile collection vehicle can include a GPS capable of providing the location of the collection vehicle with respect to at least one customer site and capable of recording positions for obtaining data for the customer profile. The trash collection vehicle can include a bar code reader which can be configured to read the bar code mounted to the container. The vehicle can include a data storage system which is capable of storing and displaying a plurality of collection routes and a plurality of customer locations. The data storage system can be used to store the database and retrieve customer profiles associated with the corresponding customers. The collection vehicle can include a positioning cylinder system which is capable of discrete position and location recording and feedback to the controller system to provide a closed-loop system. The vehicle can include an integrated hydraulic system and engine management system with performance maps linked to the customer profiles and the GPS to modify one or more parameters of the collection vehicle based upon the particular customer site at which the collection vehicle is located. The feedback can allow operator profiles to be generated and stored in a database. The operator's operator profile can be retrieved when that particular operator is running the collection vehicle. The performance of the engine and/or the hydraulic system, for example, can be controlled based on the operator's operator profile to enhance performance of the vehicle and to improve collection efficiency.

To provide an evidentiary record that the collector provided collection services on a particular day at a particular customer location, the collection vehicle can include a camera mounted thereto for taking photographs of the customer locations along the collection route. The camera can be mounted such that the act of emptying the container into the collection vehicle can be recorded. Preferably, the camera is a digital camera with the digital photographs being capable of being transmitted to the database as a database record attributable to the particular customer profile. Preferably, the photograph taken includes a portion of the environment of the customer location to allow for verification that the photograph was taken at the particular customer location. The photograph can bear a time and date stamp on it. The photograph can have other information taken from the customer profile imprinted upon it. In other embodiments, the camera can be hand-held and manipulated by the operator. In yet other embodiments, other recording devices, such as, a video recorder, for example can be used.

The trash collector can make collections at respective customer sites using a rate structure which is based on a predetermined price per unit of weight of refuse collected, for example. With a billing structure based upon use rather than simply a fixed fee, the trash collector can offer the customer an economic incentive to select the trash collector to provide collection services. The trash collector can implement a rate structure which includes a different rate for different weight ranges of refuse collected. For example, the billing rate per unit of weight collected can decrease when the customer requires refuse collection in a higher weight range.

The billing rate can include a differing price structure for collection from a container provided by the trash collector as opposed to a container not provided the collector, for example. By changing the rate structure depending upon whether the customer is using a container selected by the trash collector as opposed to a non-selected container, the refuse collection system can provide an economic incentive to modifying customer behavior toward using a container selected by the trash collector. The use of a standardized container by the trash collection provider can help the trash collector increase the efficiency of the usage of its fleet of collection vehicles, increase the efficiency of the collection route of each vehicle of the fleet, and facilitate the use of one-man collection for each collection vehicle.

The trash collector can bill each customer via an automatic method, such as, EFT or payment via debit or credit card, for example, or via any conventional billing method. The rate paid by a particular customer can be varied depending upon the billing method the customer selects. Preferably, the rate structure is configured such that there is an incentive for the customer to select a billing method which bills the customer for each collection and provides a way for the trash collector to receive funds automatically upon billing the customer.

In one embodiment of a method for collecting refuse, a mobile trash collection vehicle is provided. The collection vehicle is disposed at a customer location. The collection vehicle includes a GPS which can determine at which customer location the truck is disposed through interaction with the database. The customer profile for the customer location can be retrieved from the database. A management system located on the collection vehicle can adjust one or more parameters of the vehicle to tailor the performance of the vehicle according to the customer profile attributable to the customer location. The operating parameters can include the operation of the engine and the hydraulic system, for example. The tailoring of the performance of the collection vehicle can improve cycle time and reduce fuel usage and noise generation, for example.

An onboard bar code reader provided on the collection vehicle can be positioned by the operator of the vehicle such that it can interact with a bar code mounted to a container disposed at the customer location, at a curbside or in a container barn, for example. The bar code reader can identify the particular container in question via the bar code.

The operator of the collection vehicle can empty the container automatically via the lift mechanism or manually, for example. An onboard weighing system included on the collection vehicle can measure the weight of the trash collected from the container at the customer location. In one embodiment, the weighing system can weigh the container and the refuse collected therein. The weight of the container can be included as a database record in the database such that the weighing system can automatically deduct the weight of the container from the weight measured by the measuring system to reach the measured weight of the refuse collected. At customer locations having a plurality of containers, the same procedure can be used for all containers so located.

If the customer location includes a container which has not been selected by the collector, the operator of the collection vehicle can empty the contents of that container into the collection vehicle. The operator can input into the data storage system that the container was not a selected container. The onboard weighing system can weigh the amount of trash collected from the non-selected container and transmit the weight to the data storage system. The weighing system can take a measurement of the weight of the container and refuse stored therein. The contents of the container can be deposited in the storage area of the vehicle. The measuring system can take a measurement of the non-standardized container after its contents have been emptied to reach a measurement of the weight of the refuse collected therefrom.

After emptying the contents of each container at the customer location, the data storage system can be used to update the customer profile attributable to the particular customer location. The collection vehicle can be driven to another customer location along a collection route. Once the vehicle is at the second customer location, the procedure conducted at the first customer location can be repeated with the data obtained attributed to the customer profile for the second location.

At the end of the collection route, the collection vehicle can transmit the data from the collection activities which occurred along the collection route to a communicating system which can be located at the trash collection provider's offices, for example. In other embodiments, the collection vehicle can transmit data at other times, such as at predetermined points along the collection route, after a predetermined number of times completing the route, or substantially simultaneously upon obtaining new data. In other embodiments, the collection vehicle can transmit data to the communication system while the collection vehicle is away from the yard, for example.

The communicating system can assimilate the collection data obtained from the collection route, parcel out each specific customer's collection data, and prepare a customer collections file. Preferably, the trash collection provider's business communicating system can bill and collect funds immediately from the customer's predetermined source of funds, such as via EFT, for example.

The business system can send an e-mail, for example, to the customer confirming that trash was collected on the particular date and reporting the weight of the trash collected and the amount of funds transferred to the trash collection provider's account from the customer's account. In the event that the customer had a container emptied which was not a selected container, the business system can generate a notice which informs the customer that the billing rate for the trash collected from the non-selected container was different than the billing rate used had the container been one of the selected containers. In other embodiments, the business system can generate communications which are written on paper and sent via conventional mail or oral messages which are sent via telephone, for example. The business system can send communications within a predetermined time from when the collection services were provided, such as within 24 hours, for example.

The business communication system can enhance customer relations by providing a means for the trash collector to maintain a series of communications with each customer, each communication being within a predetermined period from the event which is the subject of the communication.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise indicated.

While the invention is described herein in connection with certain preferred embodiments, there is no intent to limit the present invention to those embodiments. On the contrary, it is recognized that various changes and modifications to the described embodiments will be apparent to those skilled in the art upon reading the foregoing description, and that such changes and modifications may be made without departing from the spirit and scope of the present invention. The inventors expect skilled artisans to employ such variations as appropriate, and the inventors intend for the invention to be practiced otherwise than as specifically described herein. Accordingly, the intent is to cover all alternatives, modifications, and equivalents included within the spirit and scope of the invention. Moreover, any combination of the above-described elements in all possible variations thereof is encompassed by the invention unless otherwise indicated herein or otherwise clearly contradicted by context.

1. A system for collecting refuse comprising:
a database including a customer profile having a database record;
a collection vehicle, the collection vehicle including a storage area for receiving refuse and a weighing system for determining the weight of the refuse collected and generating a database record of the refuse weight, the weighing system in operable arrangement with the database to send the database record of the refuse weight to the database for storing in association with the customer profile, the collection vehicle including a transmission system for transmitting the data of the database; and
a remote communication system for receiving the data from the transmission system of the collection vehicle.

2. The system according to claim 1 wherein the customer profile includes a database record of a billing rate.

3. The system according to claim 1 wherein the database comprises a computer file disposed in computer readable form on a computer readable medium.

4. The system according to claim 1 wherein the customer profile includes a database record of a customer location, and the collection vehicle includes a GPS for determining a collection vehicle location, the GPS in operable arrangement with the database to retrieve a customer profile by matching the collection vehicle location with the associated database record of the customer location.

5. The system according to claim 4 wherein the customer profile includes a database record of a collection vehicle operating parameter, and the collection vehicle includes a control unit, the control unit in operable arrangement with the database to retrieve the database record of the collection vehicle operating parameter from the customer profile, the control unit adapted to control the operation of the collection vehicle according to the database record of the collection vehicle operating parameter.

6. The system according to claim 1 wherein the customer profile includes a database record of a collection vehicle operating parameter, and the collection vehicle includes a control unit, the control unit in operable arrangement with the database to retrieve the database record of the collection vehicle operating parameter from the customer profile, the control unit adapted to control the operation of the collection vehicle according to the database record of the collection vehicle operating parameter.

7. The system according to claim 6 wherein the operating parameter is the amount of noise generated by the collection vehicle.

8. The system according to claim 1 wherein the transmission system of the collection vehicle comprises a cellular transmitter.

9. The system according to claim 1 wherein the transmission system of the collection vehicle comprises a radio transmitter.

10. The system according to claim 1 wherein the remote communication system is operable to generate a communication to a customer, the communication including the data of the customer's customer profile.

11. The system according to claim 10 wherein the communication comprises a piece of paper bearing indicia.

12. The system according to claim 10 wherein the communication comprises an electronic transmission via an electronic communication network.

13. The system according to claim 10 wherein the communication comprises an audio transmission via a telephonic network.

14. The system according to claim 1 further comprising:
a container for storing refuse to be collected by the collection vehicle.

15. The system according to claim 1 further comprising:
a plurality of containers for storing refuse before being collected by the collection vehicle, at least one of the containers being a different size than the other containers.

16. The system according to claim 14 wherein the container includes an identifier element.

17. The system according to claim 14 wherein the container includes an identifier element, and the customer profile includes a database record of the container identifier element.

18. The system according to claim 17 wherein the identifier element comprises a bar code.

19. The system according to claim 18 wherein the collection vehicle includes a reader for reading the bar code, the reader in operable arrangement with the database to retrieve the customer profile by matching the bar code read by the reader with the associated database record of the container identifier element.

20. The system according to claim 14 wherein the collection vehicle includes a lift mechanism for conveying the refuse stored in the container to the storage area of the collection vehicle.

21. A method for collecting refuse comprising:
storing a customer profile having a database record in a database;
disposing a collection vehicle at a customer location having an amount of refuse;
collecting the refuse from the customer location by conveying the refuse to a storage area of the vehicle;
determining the weight of the refuse collected from the customer location;
generating a database record of the refuse weight;
sending the database record of the refuse weight to the database for storing in association with the customer profile;
transmitting the data of the database to a remote communication system.

22. The method according to claim 21 wherein the database comprises a computer file disposed in computer readable form on a computer readable medium.

23. The method according to claim 21 wherein the customer profile includes a database record of a billing rate.

24. The method according to claim 21 wherein the customer profile includes a database record of a customer location, and the collection vehicle includes a GPS, the method further comprising:
determining a collection vehicle location;
retrieving a customer profile by matching the collection vehicle location with the associated database record of the customer location.

25. The method according to claim 24 wherein the customer profile includes a database record of a collection vehicle operating parameter, the method further comprising:
retrieving the database record of the collection vehicle operating parameter from the customer profile;
operating the collection vehicle according to the database record of the collection vehicle operating parameter.

26. The method according to claim 21 wherein the customer profile includes a database record of a collection vehicle operating parameter, the method further comprising:
retrieving the database record of the collection vehicle operating parameter from the customer profile;
operating the collection vehicle according to the database record of the collection vehicle operating parameter.

27. The method according to claim 26 wherein the operating parameter is the amount of noise generated by the collection vehicle.

28. The method according to claim 21 wherein the transmitting step comprises cellular transmitting.

29. The method according to claim 21 wherein the transmitting step comprises a radio transmitting.

30. The method according to claim 21 further comprising:
sending the data of the customer profile to the customer via the remote communication system.

31. The method according to claim 30 wherein in the sending step, the data of the customer profile is sent to the customer via a piece of paper bearing indicia.

32. The method according to claim 30 wherein in the sending step, the data of the customer profile is sent to the customer by an electronic transmission via an electronic communication network.

33. The method according to claim 30 wherein in the sending step, the data of the customer profile is sent to the customer by an audio transmission via a telephonic network.

34. The method according to claim 21 further comprising:
storing refuse in a container at the customer location.

35. The method according to claim 34 wherein the container includes an identifier element, the method further comprising:
identifying the container by the identifier element.

36. The system according to claim 35 wherein the identifier element comprises a bar code.

37. The system according to claim 36 wherein the customer profile includes a database record of the container identifier element, the method further comprising:
reading the bar code on the container;
matching the bar code read by the reader with the database record of the container identifier element.

38. The method according to claim 21 further comprising:
billing the customer for collecting the refuse from the customer location.

39. The method according to claim 38 wherein in the billing step, the customer is billed at a collection rate based on the refuse weight.

40. The method according to claim 39 wherein in the billing step, the customer is billed at a collection rate which varies based on the refuse weight.

41. The method according to claim 35 further comprising:
billing the customer for collecting the refuse from the customer location.

42. The method according to claim 41 wherein in the billing step, the customer is billed at a collection rate which varies based on whether the container is identified as being one of a group of selected containers.

43. The method according to claim 38 further comprising:
collecting funds from the customer.

44. The method according to claim 43 wherein in the collecting step, the funds are automatically collected via EFT.

45. The method according to claim 43 wherein in the collecting step, the funds are automatically collected via a credit transaction.

46. A system for collecting refuse comprising:
a container, the container including an identifier element;
a database including a customer profile having a database record of the container identifier element;
a collection vehicle, the collection vehicle including a storage area for receiving refuse and a reader, the reader in operable arrangement with the database to match the identifier element read by the reader with the database record of the container identifier element.

47. The system according to claim 46 wherein the identifier element is a bar code.

48. A method for collecting refuse comprising:
storing an operator profile having a database record of an operating parameter in a database;
retrieving the operator profile from the database with a management system of a collection vehicle;
controlling the operating parameter of the collection vehicle based on the operator profile.

49. The method according to claim 48 wherein the operating parameter is performance of an engine of the collection vehicle.

50. The method according to claim 48 wherein the operating parameter is performance of a hydraulic system of the collection vehicle.

51. A method for collecting refuse comprising:
storing a customer profile having a database record of an operating parameter in a database;
retrieving the customer profile from the database with a management system of a collection vehicle;
controlling the operating parameter of the collection vehicle based on the customer profile.

52. The method according to claim 51 wherein the operating parameter is performance of an engine of the collection vehicle.

53. The method according to claim 51 wherein the operating parameter is performance of a hydraulic system of the collection vehicle.
